(19) United States
(12) Patent Application Publication
(10) Pub. No.: US 2007/0253619 A1
(43) Pub. Date: Nov. 1, 2007

(54) Color profile generating apparatus and method

(75) Inventors: Takayuki Sawada, Numazu-shi (JP); Hiroki Kanno, Yokohama-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/411,950

(22) Filed: Apr. 27, 2006

(51) Int. Cl. G06K 9/00

(52) U.S. Cl. 382/162

(57) ABSTRACT

Even if a calculation result is out of range (e.g., below 0 or over 255 in the case of an 8-bit color signal) of a destination color signal when a color conversion table is generated by matrix calculation, clipping (non-reversible operation) is not performed, and a constant is evenly added to the matrix calculation result irrespectively of whether the value range is exceeded or not, to fit the calculation result in a predetermined data type and store as a table value. Further, subtraction of the added constant is defined as an operation immediately after table interpolation, to obtain a final correct color conversion output.

### BACKGROUND OF THE INVENTION

1. Field of the Invention

The present invention relates to a color profile generating apparatus and method, which generate a color conversion table based on calculation using a color conversion parameter.

2. Description of the Related Art

A color conversion table is used in a digital multifunction peripheral (MFP), printer, scanner, display and digital camera handing a color image.

Generally, when a color profile is generated, a color conversion matrix is obtained by a method of least squares based on measurement values of color patches of several tens to hundreds of colors, and a color conversion table is generated by calculation using the matrix. In a process of obtaining a color conversion table for conversion from PCS color coordinates to device color signal, a matrix calculation result value may go out of a device color signal value range. In this case, the value out of the device color signal value range is conventionally clipped to be within an upper or lower limit value of the range, and used as a color conversion table value (refer to FIG. 7).

However, the table value after the clipping is different from the result of matrix calculation, and the result of table interpolation obtained by referring to the table value is also different from a desired approximate value of the matrix calculation (refer to FIG. 8).

### BRIEF SUMMARY OF THE INVENTION

The object of as aspect of the present invention is to provide a color profile generating apparatus and method, which generate a color conversion table for obtaining a correct color conversion output.

According to an aspect of the present invention, there is provided a color profile generating apparatus which generates a color conversion table based on calculation using a color conversion parameter, comprising a linear equation conversion executing means for performing conversion defined by a linear equation for a calculation result using a color parameter, and outputting the result as a value stored in a color conversion table in a color profile; and a linear equation reverse conversion instruction inserting means for outputting information to instruct execution of an inverse function of the linear equation to the color conversion table, as information to define an operation immediately after table interpolation referring to the color conversion table in the color profile.

According to another aspect of the present invention, there is provided a color profile generating method for generating a color conversion table based on calculation using a color conversion parameter, comprising performing conversion defined by a linear equation for a result of calculation using a color conversion parameter, and outputting the result as a value stored in a color conversion table in a color profile; and outputting information to instruct execution of an inverse function of the linear equation to the color profile, as information to define an operation immediately after table interpolation referring to the color conversion table in the color profile.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 is a block diagram showing a color profile generating apparatus according to a first embodiment of the invention;

FIG. 2 is a diagram for explaining addition of a constant when storing data in a color conversion table;

FIG. 3 is a diagram for explaining subtraction of a constant immediately after table interpolation;

FIG. 4 is a block diagram showing a color profile generating apparatus according to a second embodiment of the invention;

FIG. 5 is a diagram for explaining addition and multiplication of a constant when storing data in a color conversion table;

FIG. 6 is a diagram for explaining division and subtraction of a constant immediately after table interpolation;

FIG. 7 is a drawing for explaining a conventional color profile generating apparatus; and

FIG. 8 is a diagram for explaining a matrix approximation error caused by clipping.

### DETAILED DESCRIPTION OF THE INVENTION

An embodiment of the invention will be explained hereinafter with reference to the accompanying drawings.

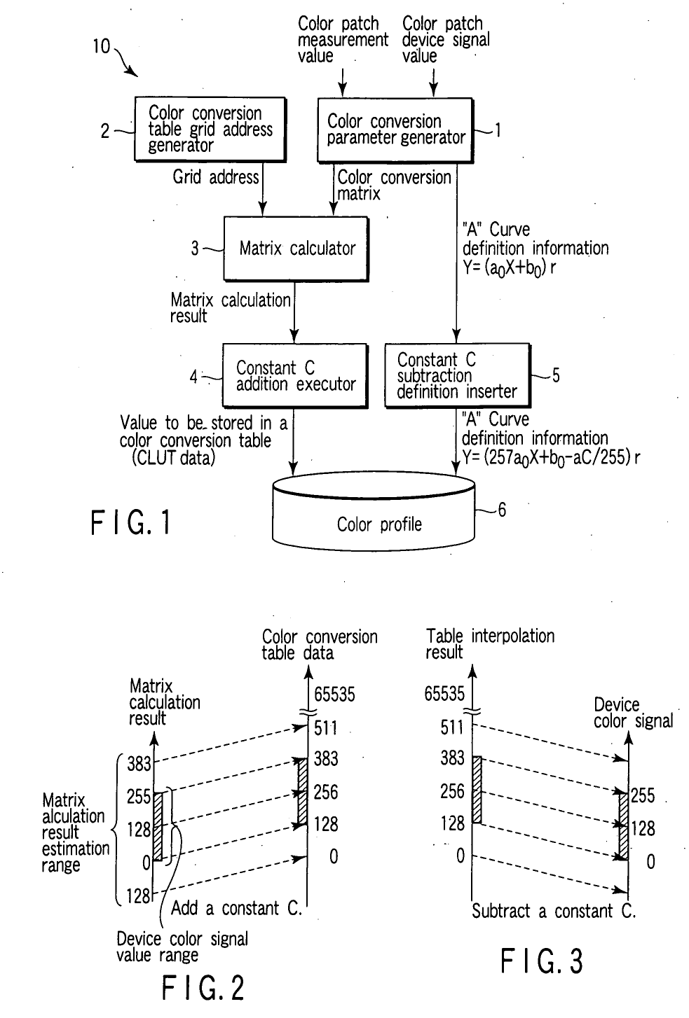

FIG. 1 is a sectional view showing the inside structure of a digital multifunction peripheral (MFP) according to an image forming apparatus of the invention.

FIG. 1 shows a first embodiment of the invention. FIG. 1 shows a color profile generating apparatus 10 comprising a color conversion parameter generator 1, a color conversion table grid address generator 2, a matrix calculator 3, a constant C addition executor 4, and a constant C subtraction definition inserter 5.

The operation of the color profile generating apparatus will be explained by taking an example of generation of a color profile of a printer.

First, measurement data of several tens to hundreds of color patches (printed in an object printer) necessary for generating a color conversion parameter, and device color signal value data to define the color patches, are input to the color conversion parameter generator 1. Based on the correspondence between the measurement data of several tens to hundreds of color patches and device color signal value data, the color conversion parameter generator 1 generates a color conversion parameter from a measurement color value space (color space to uniquely define a device-independent color, also called a profile connection color space [PCS] color signal) to a device color signal (a printer color signal in this example).

The generated color conversion parameter is composed of a color conversion matrix for calculating a matrix to a PCS color signal and a definition of gradation conversion (gamma conversion) for a later stage. The color conversion parameter generator 1 calculates a color conversion matrix by using a method of least squares, and supplies it to the matrix calculator 3. The color conversion parameter generator 1 generates a gradation conversion defining information, and supplies it to the constant C subtraction definition inserter 5.

The definition of gradation conversion corresponds to a definition of “A” Curves of parametricCurveType in B2AxTagged data (x: 0, 1, 2) of 1 utBtoAType of ICC profile. Concretely, the definition of “A” Curves is expressed by an equation Y=(a₀X+b₀)^{γ}, where X is an input and Y is an output.

The terms a₀, b₀ and γ are the parameters of the equation.

The color conversion table grid address generator 2 generates an entry grid address of a color conversion table that is a main element of a finally generated color profile, and supplies it to the matrix calculator 3. Each entry grid address is a PCS color signal expressed by a three-dimensional color coordinate value, and generated in the number equivalent to the number of entry grid points registered in the color conversion table. For example, when the number of entry grid points is 17×17×17=4913, 4913 entry grid addresses are generated.

The color conversion table corresponds to an unsigned 16-bit integer type CLUT in B2AxTagged data (x: 0, 1, 2) of 1 utBtoAType of ICC profile in this embodiment.

The matrix calculator 3 executes matrix calculation using the color conversion matrix supplied to the entry grid address, and supplies the result to the constant C addition executor 4.

In this embodiment, when generating a color conversion table for conversion from PCS color coordinates to a device color signal, the matrix calculation result coming out of the range of the device color signal value is not clipped, and a constant C is added evenly to the matrix calculation result regardless of whether the result goes out of range, and the result is used as a table value (refer to FIG. 2).

The constant C addition executor 4 adds the constant C to the matrix calculation result, and stores the result in the color conversion table. The value of the constant C is previously determined, so that an estimated range of matrix calculation result (a predetermined larger range including the whole range of a device color signal value) fits in a predetermined data type range of the color conversion table. For example, when the estimated range is −128 to 382, a result with C=128 added to the matrix calculation result is taken as a color conversion table value. A matrix calculation result out of the estimated range must be clipped to within the estimated range before the constant C is added (or clipped to within the range of table data type after the constant C is added).

In this case, the constant C is added to the result of table interpolation by the color conversion table, and it is necessary to define a constant C subtracting operation in a profile as an operation immediately after the table interpolation in order to obtain a correct final result (refer to FIG. 3).

The constant C subtraction definition inserter 5 modifies the gradation conversion definition, so that the constant C subtraction is performed before the gradation conversion (i.e., immediately after the table interpolation), and stores the modified new gradation conversion definition in the color profile 6. For example, the constant C subtraction is involved as a part of “A” Curves of parametericCurveType in B2AxTagged data of 1 utBtoAType of the ICC profile.

Concretely, when a device color signal is an unsigned 8-bit integer, the parameter a₀ is modified to (a₀*65535/255)=257a₀ for the “A” Curves equation Y=(a₀X+b₀)^{γ} in order to compensate the difference between the color conversion table data type range (0-65535 in an unsigned 16-bit integer) and device color signal value range (0-255 in an unsigned 8-bit integer), and the parameter b₀ is modified to (b₀−a₀ C/255).

Next, a second embodiment will be explained.

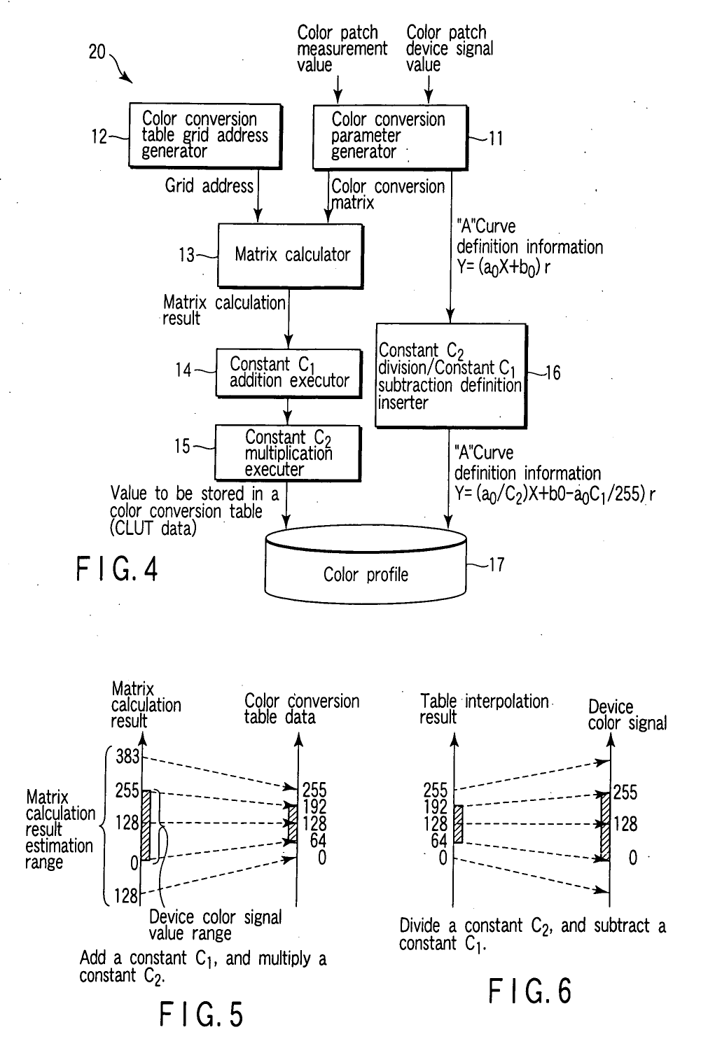

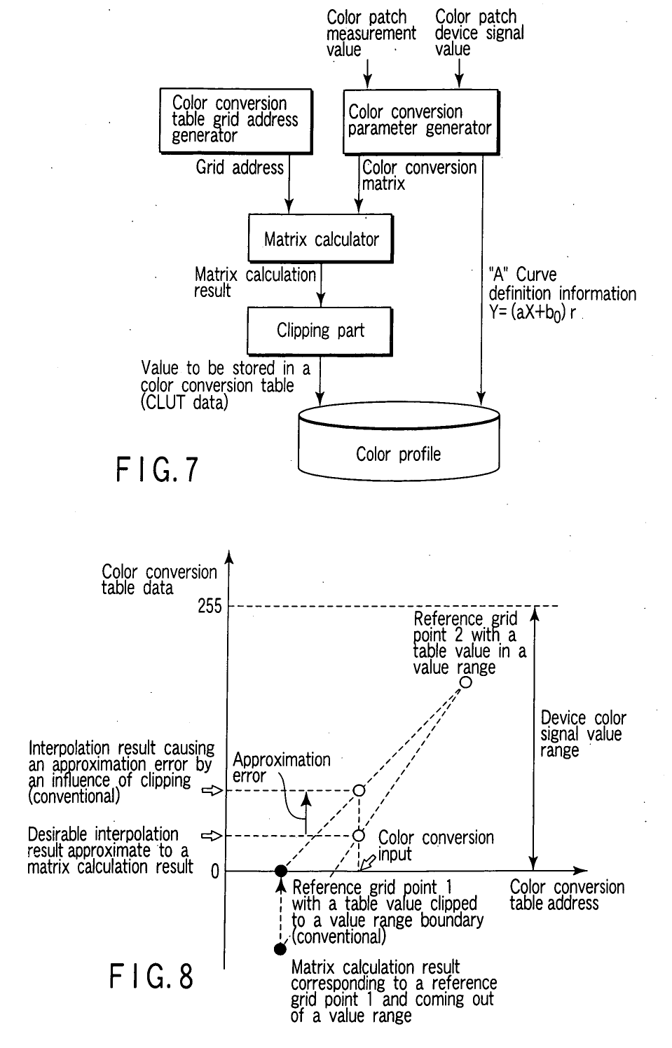

FIG. 4 shows a configuration of a second embodiment.

FIG. 4 shows a color profile generating apparatus 20 comprising a color conversion parameter generator 11, a color conversion table grid address generator 12, a matrix calculator 13, a constant C₁ addition executor 14, a constant C₂ multiplication executor 15, and a constant C₂ division/constant C₁ subtraction definition inserter 16.

The operation of the color profile generating apparatus will be explained by taking an example of generation of a color profile of a printer.

First, measurement data of several tens to hundreds of color patches (printed in an object printer) necessary for generating a color conversion parameter, and device color signal value data to define the color patches, are input to the color conversion parameter generator 11. Based on the correspondence between the measurement data of several tens to hundreds of color patches and device color signal value data, the color conversion parameter generator 11 generates a color conversion parameter from a measurement color value space (color space to uniquely define a device-independent color, also called a profile connection color space [PCS] color signal) to a device color signal (a printer color signal in this example).

The generated color conversion parameter is composed of a color conversion matrix for calculating a matrix to a PCS color signal and a definition of gradation conversion (gamma conversion) for a later stage. The color conversion parameter generator 11 calculates a color conversion matrix by using a method of least squares, and supplies it to the matrix calculator 13. The color conversion parameter generator 11 generates a gradation conversion defining information, and supplies it to the constant C₂ division/constant C₁ subtraction definition inserter 16.

The definition of gradation conversion corresponds to a definition of “A” Curves of parametricCurveType in B2AxTagged data (x: 0, 1, 2) of 1 utBtoAType of ICC profile. Concretely, the definition of “A” Curves is expressed by an equation Y=(a₀X+b₀)^{γ}, where X is an input and Y is an output.

The terms a₀, b₀ and γ are the parameters of the equation.

The color conversion table grid address generator 12 generates an entry grid address of a color conversion table that is a main element of a finally generated color profile, and supplies it to the matrix calculator 13. Each entry grid address is a PCS color signal expressed by a three-dimensional color coordinate value, and generated in the number equivalent to the number of entry grid points registered in the color conversion table. For example, when the number of entry grid points is 17×17×17=4913, 4913 entry grid addresses are generated.

The color conversion table corresponds to an unsigned 8-bit integer type CLUT in B2AxTagged data (x: 0, 1, 2) of 1 utBtoAType of ICC profile in this embodiment.

The matrix calculator 13 executes matrix calculation using the color conversion matrix supplied to the entry grid address, and supplies the result to the constant C₁ addition executor 14.

In this embodiment, as the color conversion table data type range is equal to the device color signal value range (both are an unsigned 8-bit integer), the constant C₁ addition executor 14 adds the constant C₁ to the matrix calculation result, and further the constant C₂ multiplication executor 15 multiplies the constant C₂, so that an estimated range of matrix calculation result (a predetermined larger range including the whole range of a device color signal value) fits in a predetermined data type range.

For example, when the estimated range is −128 to 382, C₁=128 is added to the matrix calculation result, and further C₂=0.5 is multiplied, and the result is taken as a color conversion table value (refer to FIG. 5). A matrix calculation result out of the estimated range is clipped to within the estimated range before the constant C₁ is added (or clipped to within the range of table data type after the constant C₂ is multiplied).

In this case, the constant C₁ is added and C₂ is multiplied to the result of table interpolation by the color conversion table, and it is necessary to define constant C₂ division and C₁ subtraction in a profile as operations immediately after the table interpolation in order to obtain a correct final result (refer to FIG. 6).

The constant C₂ division/constant C₁ subtraction definition inserter 16 modifies the gradation conversion definition, so that the constant C₂ division and constant C₁ subtraction are performed before the gradation conversion (i.e., immediately after the table interpolation), and stores the modified new gradation conversion definition in the color profile 17. For example, the inserter 16 modifies the parameter a₀ to a₀/C₂ and parameter b₀ to (b₀−a₀C₁/255) for the “A” Curves equation γ=(a₀X+b₀)^{γ}.

As explained hereinbefore, according to the embodiments of the invention, even if the calculation result to be taken as a table value is out of the range of the device color signal value (e.g., below 0 or over 255 in case of an 8-bit color signal) when a color conversion table is generated by matrix calculation, clipping (non-linear operation or non-reversible operation) is not performed, and a reversible operation by a linear equation is evenly performed for the matrix calculation result irrespectively of whether the range of the device color signal value is exceeded or not. Therefore, the calculation result is fitted in a predetermined data type and stored as a table value. The result of table interpolation predicts the operation result of matrix calculation result by the linear equation without an influence of conventional clipping.

Further, as an operation reverse to the operation by the liner equation is defined as an operation immediately after the color conversion table in a color profile to be generated, the matrix calculation result itself can be finally predicted without an influence of conventional clipping.

In particular, according to the second embodiment, as the scaling conversion is performed by making multiplication effective in the linear equation, the matrix calculation result can be predicted by the table interpolation and subsequent operation without an influence of conventional clipping, even if the data type range of color conversion table is equal to the range of the device color signal value and there is no margin to involve an estimated rage of matrix calculation result.

The invention is usable for generation of ICC profile that is an industry standard of color profile format, by applying CLUT included in C2AxTagged data (x: 0, 1, 2) of 1 utBtoA type and “A” Curves of parametricCurve. Moreover, B2AxTag is an ICC standard tag, and a private tag is unnecessary to use. Any color management module (CMM) applicable to the ICC profile can use the ICC profile generated by the color profile generating apparatus of the invention, and obtain the effect.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A color profile generating apparatus which generates a color conversion table based on calculation using a color conversion parameter, comprising:
a linear equation conversion executing means for performing conversion defined by a linear equation for a calculation result using a color parameter, and outputting the result as a value stored in a color conversion table in a color profile; and
a linear equation reverse conversion instruction inserting means for outputting information to instruct execution of an inverse function of the linear equation to the color profile, as information to define an operation immediately after table interpolation referring to the color conversion table in the color profile.

2. The color profile generating apparatus according to claim 1, wherein the linear equation conversion executing means includes an operation of multiplying a coefficient lower than 1 for an input variable to the linear equation.

3. A color profile generating apparatus which generates a color conversion table based on calculation using a color conversion parameter, comprising:
a linear equation conversion executing means for performing conversion defined by a linear equation for a calculation result using a color parameter, and outputting the result as a value stored in an unsigned 8-bit integer type color conversion table in a color profile; and
a linear equation reverse conversion instruction inserting means for outputting information to instruct execution of an inverse function of the linear equation to the color profile, as information to define an operation immediately after the table interpolation in the color profile.

4. The color profile generating apparatus according to claim 3, wherein the linear equation conversion executing means includes an operation of multiplying a coefficient lower than 1 for an input variable to the linear equation.

5. The color profile generating apparatus according to claim 3, wherein the linear equation conversion executing means performs conversion defined by a linear equation for the calculation result using a color parameter, and outputs the result as a value stored in an unsigned 16-bit integer type color conversion table in a color profile.

6. The color profile generating apparatus according to claim 3, wherein the information to instruct execution of an inverse function of the linear equation output by the linear equation reverse conversion instruction inserting means is a part of “A” Curves setting of parametricCurveType in B2AxTagged data (x: 0, 1, 2) of 1 utBtoAType in ICC profile.

7. A color profile generating apparatus which generates a color conversion table based on calculation using a color conversion parameter, comprising:
a linear equation conversion executing means for performing conversion defined by a linear equation for the calculation result using a color parameter, and outputting the result as a value stored in an unsigned 16-bit integer type color conversion table in a color profile;
a standardizing instruction inserting means for outputting information to instruct standardization of the output value of table interpolation referring to the color conversion table as a maximum 8-bit integer value to the color profile, as information to define an operation immediately after the table interpolation in the color profile; and
a linear equation reverse conversion instruction inserting means for outputting information to instruct execution of an inverse function of the linear equation to the color profile, as information to define an operation immediately after the standardization in the color profile.

8. The color profile generating apparatus according to claim 7, wherein the information to instruct standardization output by the standardizing instruction inserting means and information to instruct execution of an inverse function of the linear equation output by the linear equation reverse conversion instruction inserting means are a part of “A” Curves setting of parametricCurveType in B2AxTagged data (x: 0, 1, 2) of 1 utBtoAType in ICC profile.

9. A color profile generating method for generating a color conversion table based on calculation using a color conversion parameter, comprising:
performing conversion defined by a linear equation for the result of calculation using a color conversion parameter and outputting the result as a value stored in a color conversion table in a color profile; and
outputting information to instruct execution of an inverse function of the linear equation to the color profile, as information to define an operation immediately after table interpolation referring to the color conversion table in the color profile.

10. A color profile generating method for generating a color conversion table based on calculation using a color conversion parameter, comprising:
performing conversion defined by a linear equation for the calculation result using a color parameter, and outputting the result as a value stored in an unsigned 8-bit integer type color conversion table in a color profile; and
outputting information to instruct execution of an inverse function of the linear equation to the color profile, as information to define an operation immediately after the table interpolation in the color profile.

11. The color profile generating method according to claim 10, further comprising performing conversion defined by a linear equation for the calculation result using a color parameter, and outputs the result as a value stored in an unsigned 16-bit integer type color conversion table in the color profile.

12. A color profile generating method for generating a color conversion table based on calculation using a color conversion parameter, comprising:
performing conversion defined by a linear equation for the calculation result using a color parameter, and outputting the result as a value stored in an unsigned 16-bit integer type color conversion table in a color profile;
outputting information to instruct standardization of the output value of table interpolation referring to the color conversion table as a maximum 8-bit integer value to the color profile, as information to define an operation immediately after the table interpolation in the color profile; and
outputting information to instruct execution of an inverse function of the linear equation to the color profile, as information to define an operation immediately after the standardization in the color profile.
